(19) United States
(12) Patent Application Publication
(10) Pub. No.: US 2022/0191315 A1
(43) Pub. Date: Jun. 16, 2022

(54) UNIVERSAL PHONE ADAPTER SYSTEM AND METHOD

(71) Applicant: Alicia Booth, Arnold, MD (US)

(72) Inventor: Alicia Booth, Arnold, MD (US)

(21) Appl. No.: 17/118,963

(22) Filed: Dec. 11, 2020

(51) Int. Cl. H04M 1/247; H04R 25/00; H04R 1/08

(52) U.S. Cl. CPC H04M 1/2475; H04R 2225/67; H04R 1/08; H04R 25/556

(57) ABSTRACT

A system for assisting hearing-impaired persons using landline telephones is provided. The system comprises a portable electronic device that receives a first plurality of electronic signals from a telephone landline via a female modular RJ9 jack resident in the device, the signals comprising audible content. The system routes the first plurality of electronic signals to a first female auditory output resident in the device. The system transmits the signals to a first male-ended listening device connected to the first auditory output. The first male-ended listening device is a hearing aid device accessory adapter used by a first user wearing a hearing aid or a cochlear implant. The portable electronic device receives second electronic signals at a female auditory input from the first user, the second electronic signals representing spoken audible content provided by the first user. A second male-ended device comprising a microphone connects with the auditory input.

### CROSS REFERENCE TO RELATED APPLICATIONS

The present disclosure is related to U.S. Provisional Patent Application No. 63/081,620 filed Sep. 22, 2020, the contents of which are incorporated herein in their entirety.

### FIELD OF THE INVENTION

The present disclosure is in the field of telephony for disabled persons. More particularly, the present disclosure provides systems and methods of allowing a hearing-impaired person to use a telephone landline with improved clarity and volume.

### BACKGROUND

Despite the widespread popularity of mobile devices, landline telephones are commonplace in offices, hotels and hospitals and are expected to remain so for decades. However, landline phones, wherein a handset receiver is physically connected to a handset cord, can be difficult to use for persons with hearing disabilities. Volume and clarity often suffer for hearing-impaired persons using landlines.

Particularly when away from their homes and offices and using a landline with which they are not familiar, hearing impaired persons, which may include those who wear a hearing aid or cochlear implant, often have difficulty clearly hearing sounds coming from the landline receiver. Present solutions are cumbersome and technically difficult.

In a hospital setting, for example, a physician may move rapidly from one area of the hospital to another. He/she may need to place or receive calls on landline telephones from many different locations in the hospital, and with little notice. A physician who is hearing-impaired may need a convenient and lightweight way to engage in landline communications without being concerned with whether he/she can clearly hear.

### BRIEF DESCRIPTION OF THE FIGURE

FIG. 1 is an image of a universal phone adapter system in accordance with an embodiment of the present disclosure.

FIG. 2 is an image of a universal phone adapter system in accordance with an embodiment of the present disclosure.

FIG. 3 is an image of a universal phone adapter system in accordance with an embodiment of the present disclosure.

### DETAILED DESCRIPTION

A universal phone adapter is provided herein that enables a person wearing a hearing aid or cochlear implant to use a landline telephone when away from his/her home or office. A user may carry the lightweight universal phone adapter provided herein in a purse or pocket. The user would carry the universal phone adapter along with his/her own hearing aid device accessory adapter and microphone, both fitted with 3.5 mm male-ended jacks.

The universal phone adapter contains three 3.5 mm female jacks, two for output and one for input. A first jack for output is for the user's own hearing aid device accessory adapter. A second output jack may be used for earphones by a second user. The single input jack is used for microphone insertion by the user and allows the user to speak.

All three 3.5 mm female jacks connect via circuits and other internal electronic components to a female RJ9 jack. The female RJ9 jack is joined to a male RJ9 jack at the end of the landline handset cord after the receiver has been removed from the cord. The user may then receive and place calls at the landline and receive clear sound at an acceptable volume.

A hearing-impaired user seeking to initiate or receive a call at a landline may lift the handset or receiver from the phone and then unplug the receiver from the handset cord, leaving the male-ended RJ9 connector exposed. The user then plugs the male-ended RJ9 connector on the handset cord into an optional reversing cord that may be necessary to deal with different polarities of phones. The reversing cord then plugs into the RJ9 female modular jack on the universal phone adapter.

The reversing cord may not be necessary. In these cases, the RJ9 connector on the handset cord would plug directly into the female RJ9 modular jack on the universal phone adapter.

The microphone plugs into the 3.5 mm jack on the universal phone adapter designated “mic”. The microphone may be a commercial, off-the-shelf microphone.

The user plugs his/her own hearing aid device accessory adapter into the 3.5 mm jack on the universal phone adapter designated “ci”. The hearing aid device accessory adapter may also be available on a commercial, off-the-shelf basis.

If a second person wishes to join the call with the user, an optional set of earphones plug into the 3.5 mm jack on the universal phone adapter designated “ear.”

The universal phone adapter does not power itself. It draws power from the landline handset to which the universal phone adapter is attached.

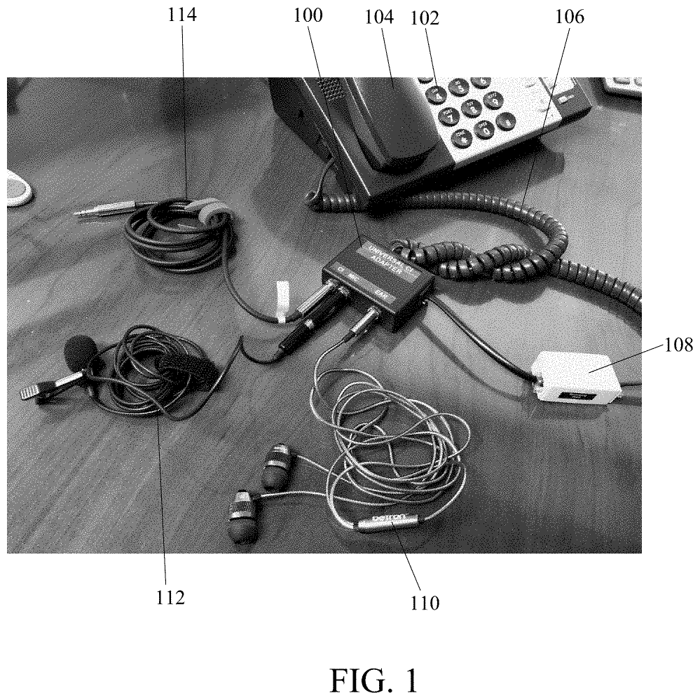

Turning to the figures, FIG. 1 is an image of system of a universal phone adapter as provided herein. FIG. 1 depicts the universal phone adapter 100 or adapter 100, a phone base 102, a handset 104, a handset cord 106, an optional reversing cord 108, optional earphones 110, and a microphone 112. The male-ended RJ9 connector in FIG. 1 is at the end of the optional reversing cord 108 and is inserted into the female RJ9 modular jack resident in the adapter 100.

FIG. 1 also depicts a double-ended adapter 114 which is illustrated herein purely to point out the location of the 3.5 mm jack designated “ci”. The double-ended adapter 114 is depicted in FIG. 1 in a coiled state with a small pink device holding the double-ended adapter 114 in its coiled state.

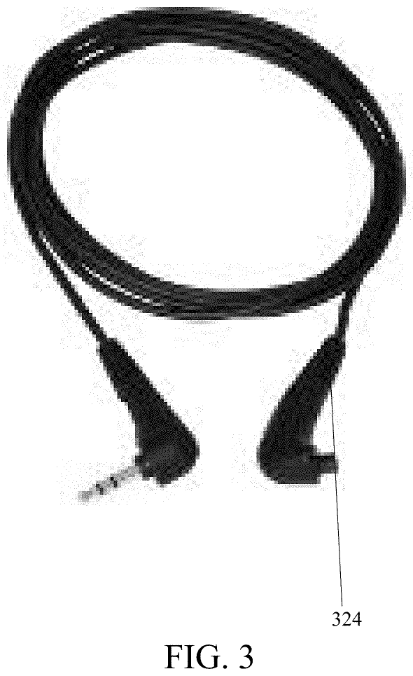

As noted, the jack designated “ci” is the location at which the user's own hearing aid device accessory adapter is plugged. The hearing aid device accessory adapter is not shown in FIG. 1 and is instead illustrated in FIG. 3.

All of the components shown in FIG. 1 except the adapter 100 are available as commercial, off-the-shelf products. Systems provided herein are limited to the adapter 102.

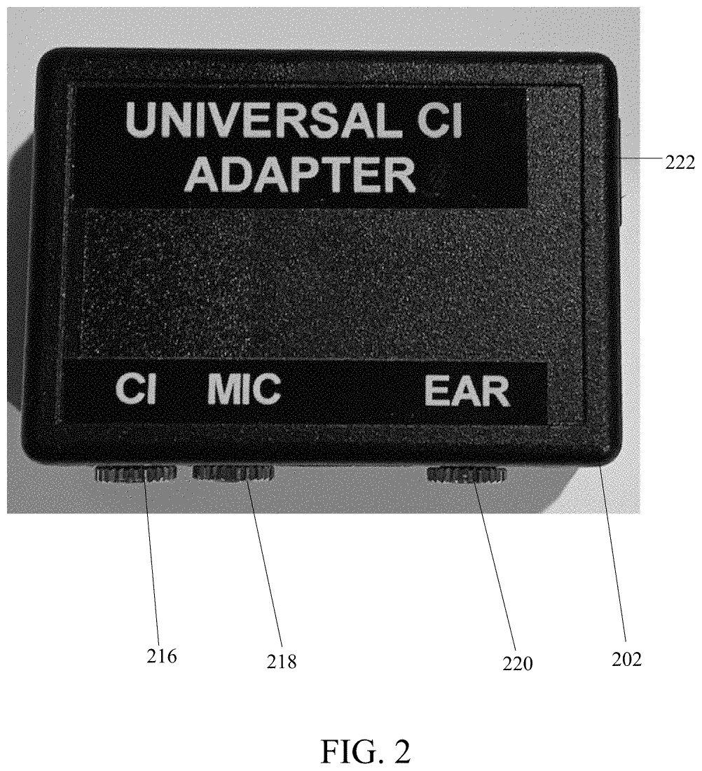

Components in FIG. 2 and FIG. 3 are indexed to the components shown in FIG. 1.

FIG. 2 is an image of the universal phone adapter 202. FIG. 2 also depicts close up views of a ci jack 216, a mic jack 218, and an ear jack 220, each of which is a 3.5 mm female jack. Also shown in FIG. 2 is the female RJ modular jack 222.

FIG. 3 is an image of a hearing aid device accessory adapter 324 that the user may carry on his/her person along with the adapter 100 and microphone 112. The hearing aid device accessory adapter 324 pugs into the ci jack 2126 and is, as noted, a commercial off-the-shelf component.

In an embodiment, a system for assisting hearing-impaired persons using landline telephones is provided. The system comprises a portable electronic device that receives a first plurality of electronic signals from a telephone landline via a female modular RJ9 jack resident in the device, the signals comprising audible content. The system routes the first plurality of electronic signals to a first female auditory output resident in the device. The system transmits the signals to a first male-ended listening device connected to the first auditory output.

The first male-ended listening device is a hearing aid device accessory adapter. The hearing aid device accessory adapter is used by a first user wearing a hearing aid or a cochlear implant.

The portable electronic device receives second electronic signals at a female auditory input resident in the device from the first user, the second electronic signals representing spoken audible content provided by the first user. A second male-ended device comprising a microphone connects with the auditory input.

The portable electronic device additionally transmits the first electronic signals to a second male-ended listening device connected to a second female auditory output resident in the device, the second male-ended device comprising earphones used by a non-hearing impaired second user. The first auditory output, the second auditory output, and the first auditory input are 3.5 mm female jacks. The first plurality of electronic signals are received at a female RJ9 jack resident in the device from a telephone landline handset cord.

A handset receiver is removed from the handset cord prior to insertion of a male-ended RJ9 connector on the handset cord into the female RJ9 jack. The device draws power from the handset cord.

In another embodiment, a method of assisting hearing-impaired persons using landline telephones is provided. The method comprises a portable electronic device with first and second 3.5 mm female auditory outputs, with a first 3.5 mm female auditory input, and with a female RJ9 female modular jack receiving a first plurality of electronic signals via the first auditory input. The method further comprises the portable electronic device routing the first plurality of electronic signals to the RJ9 female modular jack.

The method further comprises the portable electronic device transmitting the first plurality of electronic signals to a male-ended RJ9 connector joined to the RJ9 female jack. The first plurality of electronic signals represents spoken content. The portable electronic device receives insertion of a microphone with a male-ended 3.5 mm connector into the first auditory input.

The portable electronic device receives a second plurality of electronic signals from the male-ended RJ9 connector, the second plurality of electronic signals comprising spoken content originated by a landline telephone. The male-ended RJ9 connector is situated at an end of a handset cord of the landline telephone.

In yet another embodiment, a system for assisting hearing-impaired persons using landline telephones is provided. The system comprises a portable electronic device comprising two auditory outputs, one auditory input, and an RJ9 modular jack that receives first electronic signals via the jack. The device also transmits the signals to the two auditory outputs, receives second electronic signals from the auditory input, and transmits the second signals to the jack.

The jack is an RJ9 female modular jack joined to an RJ9 male-ended jack attached to a landline telephone handset cord. A first auditory output is a 3.5 mm female connector that receives connection with a hearing aid device accessory adapter used by a first user wearing one of a hearing aid or fitted with a cochlear implant.

The auditory output is a 3.5 mm female connector that receives connection with a microphone used by the user to speak to a user of the landline telephone. The first electronic signals and the second electronic signals provide audible content.

What is claimed is:

1. A system for assisting hearing-impaired persons using landline telephones, comprising:
a portable electronic device that:
receives a first plurality of electronic signals from a telephone landline via a female modular RJ9 jack resident in the device, the signals comprising audible content,
routes the first plurality of electronic signals to a first female auditory output resident in the device, and
transmits the signals to a first male-ended listening device connected to the first auditory output.

2. The system of claim 1, wherein the first male-ended listening device is a hearing aid device accessory adapter.

3. The system of claim 2, wherein the hearing aid device accessory adapter is used by a first user wearing a hearing aid or a cochlear implant.

4. The system of claim 1, wherein the portable electronic device receives second electronic signals at a female auditory input resident in the device from the first user, the second electronic signals representing spoken audible content provided by the first user.

5. The system of claim 4, wherein a second male-ended device comprising a microphone connects with the female auditory input.

6. The system of claim 1, wherein the portable electronic device additionally transmits the first electronic signals to a second male-ended listening device connected to a second female auditory output resident in the portable electronic device, the second male-ended device comprising earphones used by a non-hearing impaired second user.

7. The system of claim 1, wherein the first auditory output, the second auditory output, and the first auditory input are 3.5 mm female jacks.

8. The system of claim 1, wherein the first plurality of electronic signals are received at a female RJ9 jack resident in the device from a telephone landline handset cord.

9. The system of claim 7, wherein a handset receiver is removed from the handset cord prior to insertion of a male-ended RJ9 connector on the handset cord into the female RJ9 jack.

10. The system of claim 1, wherein the device draws power from the handset cord.

11. A method of assisting hearing-impaired persons using landline telephones, comprising:
a portable electronic device with first and second 3.5 mm female auditory outputs, with a first 3.5 mm female auditory input, and with a female RJ9 female modular jack receiving a first plurality of electronic signals via the first auditory input;
the portable electronic device routing the first plurality of electronic signals to the RJ9 female modular jack; and
the portable electronic device transmitting the first plurality of electronic signals to a male-ended RJ9 connector joined to the RJ9 female jack.

12. The method of claim 11, further comprising the first plurality of electronic signals representing spoken content.

13. The method of claim 11, further comprising the portable electronic device receiving insertion of a microphone with a male-ended 3.5 mm connector into the first auditory input.

14. The method of claim 11, further comprising the portable electronic device receiving a second plurality of electronic signals at the RJ9 connector, the second plurality of electronic signals comprising spoken content originated by a landline telephone.

15. The method of claim 11, wherein the male-ended RJ9 connector is situated at an end of a handset cord of the landline telephone.

16. A system for assisting hearing-impaired persons using landline telephones, comprising:
a portable electronic device comprising two auditory outputs, one auditory input, and an RJ9 modular jack that:
receives first electronic signals via the jack,
transmits the signals to the two auditory outputs,
receives second electronic signals from the auditory input, and
transmits the second signals to the jack.

17. The system of claim 16, wherein the jack is an RJ9 female modular jack joined to an RJ9 male-ended jack attached to a landline telephone handset cord.

18. The system of claim 16, wherein a first auditory output of the two auditory outputs is a 3.5 mm female connector that receives connection with a hearing aid device accessory adapter used by a first user wearing one of a hearing aid or fitted with a cochlear implant.

19. The system of claim 16, wherein a second auditory output of the two auditory outputs is a 3.5 mm female connector that receives connection with a male-ended microphone used by the user to speak to a user of the landline telephone.

20. The system of claim 16, wherein the first electronic signals and the second electronic signals provide audible content.
